(19) United States
(12) Patent Application Publication
(10) Pub. No.: US 2025/0300207 A1
(43) Pub. Date: Sep. 25, 2025

(54) FUEL CELL SYSTEM

(71) Applicant: Honda Motor Co., Ltd., Tokyo (JP)

(72) Inventors: Taishi Yamaguchi, Saitama (JP); Kazusa Ishikawa, Saitama (JP); Yuta Noma, Taito-ku, Tokyo (JP)

(21) Appl. No.: 19/060,941

(22) Filed: Feb. 24, 2025

(30) Foreign Application Priority Data
Mar. 25, 2024 (JP) 2024-047486

(51) Int. Cl. H01M 8/04746; H01M 8/0438; H01M 8/1004; H01M 8/2457

(52) U.S. Cl. CPC H01M 8/04783; H01M 8/04388; H01M 8/04395; H01M 8/04432; H01M 8/04753; H01M 8/1004; H01M 8/2457

(57) ABSTRACT

A fuel cell system includes: a fuel cell stack constituted by stacking a plurality of power generation cells; an injector configured to inject fuel gas to be supplied to the fuel cell stack; a pressure sensor configured to detect a pressure of the fuel gas to be supplied to the fuel cell stack; and a control unit configured to set an injection cycle of the injector and to control the injector to inject the fuel gas in the injection cycle. The control unit controls the injector to inject the fuel gas earlier than lapse of the injection cycle when a pressure difference between the pressure detected by the pressure sensor and a target pressure becomes equal to or larger than a predetermined value.

### CROSS-REFERENCE TO RELATED APPLICATION

This application is based upon and claims the benefit of priority from Japanese Patent Application No. 2024-047486 filed on Mar. 25, 2024, the content of which is incorporated herein by reference.

### BACKGROUND OF THE INVENTION

### Field of the Invention

The present invention relates to a fuel cell system.

### Description of the Related Art

Use of a fuel cell as a drive source of a vehicle or the like can contribute to improvement of energy efficiency. As a technique related to such a fuel cell, a device that controls an injector that injects a fuel gas of a fuel cell is conventionally known. For example, in the device described in JP 2014-102948 A, the target pressure of the fuel gas flowing into a fuel gas flow path is set at every predetermined cycle, the pressure of the fuel gas flowing into the fuel gas flow path is detected, the driving of a plurality of injectors is controlled such that the detected pressure approaches the target pressure, and the drive cycle of the injectors is set to be shorter at the time of system start than that at the time of normal control.

However, even if the drive cycle is adjusted as in the device described in JP 2014-102948 A, in a predetermined operation state such as the time of purge for discharging impurities from the fuel gas circulation flow path or acceleration of the vehicle in which the required power generation amount rapidly increases, there is a possibility that the pressure of the fuel gas temporarily decreases with respect to the target pressure and a generated voltage decreases.

### SUMMARY OF THE INVENTION

An aspect of the present invention is a fuel cell system, including: a fuel cell stack constituted by stacking a plurality of power generation cells; an injector configured to inject fuel gas to be supplied to the fuel cell stack; a pressure sensor configured to detect a pressure of the fuel gas to be supplied to the fuel cell stack; and a control unit configured to set an injection cycle of the injector and to control the injector to inject the fuel gas in the injection cycle. The control unit controls the injector to inject the fuel gas earlier than lapse of the injection cycle when a pressure difference between the pressure detected by the pressure sensor and a target pressure becomes equal to or larger than a predetermined value.

### BRIEF DESCRIPTION OF THE DRAWINGS

The objects, features, and advantages of the present invention will become clearer from the following description of embodiments in relation to the attached drawings, in which:

FIG. 1 is a diagram schematically illustrating an example of an overall configuration of a fuel cell system according to an embodiment of the present invention;

FIG. 2 is a time chart for explaining injection order of a large-diameter injector and a small-diameter injector in FIG. 1;

FIG. 3A is a time chart for explaining decrease in pressure of fuel gas when purging;

FIG. 3B is a time chart, corresponding FIG. 3A, for explaining suppression of the decrease in the pressure due to interruption injection;

FIG. 4A is a time chart for explaining decrease in the pressure of the fuel gas when accelerating;

FIG. 4B is a time chart, corresponding FIG. 4A, for explaining suppression of the decrease in the pressure due to the interruption injection;

FIG. 5 is a flowchart illustrating an example of injection permission determination processing executed by an ECU in FIG. 1;

FIG. 6A is a time chart for explaining increase in the pressure of the fuel gas in a case where the interruption injection is permitted even when the large-diameter injector is opened;

FIG. 6B is a time chart for explaining increase in the pressure of the fuel gas in a case where the interruption injection is permitted on condition that the large-diameter injector is closed;

FIG. 7 is a flowchart illustrating an example of valve opening time setting processing executed by the ECU in FIG. 1; and

FIG. 8 is a diagram for explaining the valve opening time of each injector set by the ECU in FIG. 1.

### DETAILED DESCRIPTION OF THE INVENTION

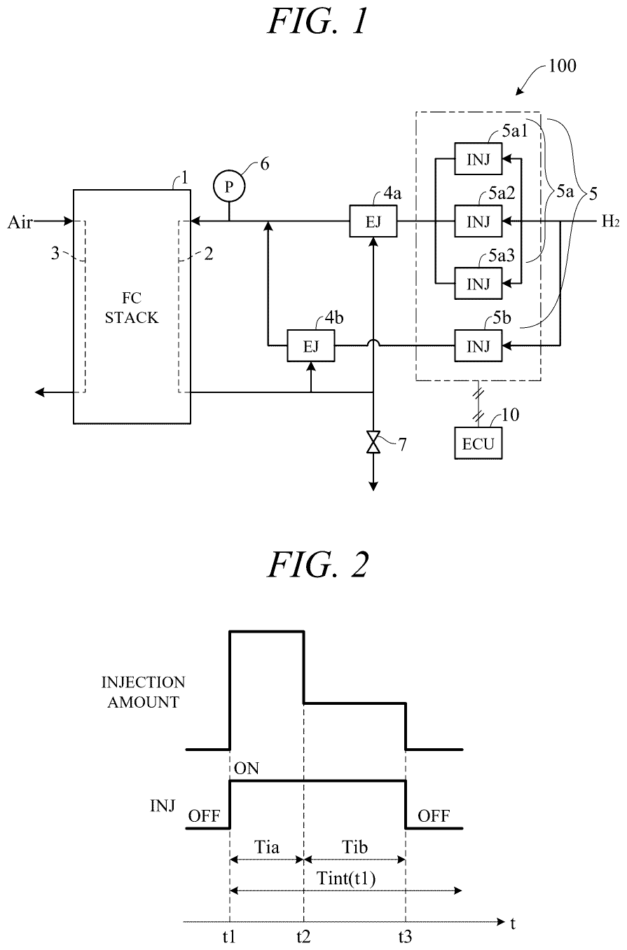

Hereinafter, an embodiment of the present invention will be described with reference to FIGS. 1 to 8. FIG. 1 is a diagram schematically illustrating an example of an overall configuration of a fuel cell system 100 according to an embodiment of the present invention. As illustrated in FIG. 1, the fuel cell system 100 mainly includes a fuel cell stack 1 formed by stacking a plurality of power generation cells, and an electronic control unit (ECU) 10 that controls each unit of the fuel cell system 100. The fuel cell system 100 is mounted on a vehicle, for example, and can generate electric power for driving the vehicle. The fuel cell system 100 can be mounted on a moving body, such as an aircraft or a ship, other than a vehicle, a robot, or various types of industrial machine.

Each power generation cell of the fuel cell stack 1 has a membrane electrode assembly (MEA) in which electrodes (such as an electrode catalyst layer and a gas diffusion layer) are provided on both surfaces of a solid polymer electrolyte membrane. A fuel gas containing hydrogen is supplied to an anode electrode of each power generation cell of the fuel cell stack 1 through an anode flow path 2, and an oxidant gas such as air containing oxygen is supplied to a cathode electrode through a cathode flow path 3. Accordingly, an electrochemical reaction proceeds in the electrode of each power generation cell, and power generation is performed in the fuel cell stack 1.

An oxidant gas such as compressed air is supplied to the cathode flow path 3 via a compressor (not illustrated). The oxidant gas supplied to the cathode flow path 3 is partially used in the cathode electrode, and then discharged from the cathode flow path 3 to the outside as an oxidant exhaust gas.

A fuel gas tank in which a high-pressure fuel gas is stored is connected to the anode flow path 2 via ejectors 4a and 4b, an injector 5, and a decompression valve (pressure adjusting valve) (not illustrated). The fuel gas in the fuel gas tank is decompressed to a predetermined supply pressure by the decompression valve, then injected by the injector 5, and supplied to the anode flow path 2 via the ejectors 4a and 4b.

The injector 5 includes a valve body that opens and closes an injection hole and a coil that drives the valve body, and is controlled by the ECU 10. More specifically, a drive current is supplied to the coil of the injector 5 via a driver circuit (not illustrated) in accordance with an opening/closing command from the ECU 10, whereby the injector 5 is driven to be opened and closed. That is, the injector 5 is opened when the coil is energized according to an ON command from the ECU 10, and the injector 5 is closed when the energization to the coil is cut off in accordance with an OFF command from the ECU 10. When the injector 5 is opened, the fuel gas decompressed to a predetermined supply pressure by the decompression valve is injected and supplied to the anode flow path 2.

The fuel gas supplied to the anode flow path 2 is partially used by the anode electrode, and then discharged from the anode flow path 2 as a fuel exhaust gas. The fuel exhaust gas includes, in addition to fuel gas (hydrogen), permeated nitrogen or permeated water vapor that permeates from the cathode side to the anode side through the membrane electrode assembly. The fuel exhaust gas discharged from the anode flow path 2 is sucked as an anode recirculation gas via the ejectors 4a and 4b after water is separated via a gas-liquid separator (not illustrated), and supplied (recirculated) to the anode flow path 2 again.

The injector 5 includes a large-diameter injector 5a and a small-diameter injector 5b provided in parallel with each other. The effective cross-sectional area of the injection hole of the large-diameter injector 5a is larger than the effective cross-sectional area of the injection hole of the small-diameter injector 5b, and the injection amount per unit time of the large-diameter injector 5a is larger than the injection amount per unit time of the small-diameter injector 5b.

The large-diameter injector 5a may be configured as a single injector having a larger hole diameter than that of the small-diameter injector 5b, or may be configured as a plurality of injectors having the same hole diameter as that of the small-diameter injector 5b. Hereinafter, an example will be described in which the large-diameter injector 5a includes three large-diameter injectors 5a1 to 5a3 having a larger hole diameter than the small-diameter injector 5b. The large-diameter injectors 5a1 to 5a3 are provided in parallel with each other. The fuel gas injected from the large-diameter injectors 5a1 to 5a3 is supplied to the anode flow path 2 via the ejector 4a, and the fuel gas injected from the small-diameter injector 5b is supplied to the anode flow path 2 via the ejector 4b.

The fuel gas injected from each injector 5 flows into the nozzle portions of the ejectors 4a and 4b and is accelerated, and a low-pressure space is generated in the ejectors 4a and 4b, so that the fuel exhaust gas discharged from the anode flow path 2 is sucked into the ejectors 4a and 4b. The fuel gas and the fuel exhaust gas combined in the ejectors 4a and 4b are ejected through the diffuser portions of the ejectors 4a and 4b while being mixed together, and are supplied to the anode flow path 2. Hereinafter, the mixed gas ejected from the ejectors 4a and 4b and supplied to the anode flow path 2 is referred to as an “anode supply gas”. The anode supply gas includes a fuel gas (hydrogen), a permeated nitrogen, and a permeated water vapor.

A pressure sensor 6 that detects a pressure P of the fuel gas supplied to the fuel cell stack 1 is provided near the inlet of the anode flow path 2. Specifically, the pressure sensor 6 detects the pressure (total pressure) of the anode supply gas including the fuel gas. The hydrogen partial pressure of the anode supply gas corresponding to the pressure P of the fuel gas (hydrogen) can be calculated by subtracting the nitrogen partial pressure and the water vapor partial pressure of the anode supply gas from the total pressure of the anode supply gas detected by the pressure sensor 6. The nitrogen partial pressure and the water vapor partial pressure of the anode supply gas can be calculated based on the flow rates (permeation amounts) of the permeated nitrogen and the permeated water vapor and the discharge amount of the anode recirculation gas described later. The permeation amount can be calculated based on the power generation amount (current value) of the fuel cell stack 1 and a power generation state such as a stack temperature.

Near the outlet of the anode flow path 2, an on-off valve 7 that opens and closes a discharge path which connects a reflux path connecting the anode flow path 2 and the ejectors 4a and 4b to the outside is provided. The on-off valve 7 is normally closed. When the on-off valve 7 is closed, the anode recirculation gas flowing through the reflux path is returned to the anode flow path 2 via the ejectors 4a and 4b without being discharged to the outside. When the hydrogen concentration (relative hydrogen partial pressure) of the anode supply gas decreases due to an increase in the nitrogen concentration (relative nitrogen partial pressure) of the anode supply gas, the on-off valve 7 is temporarily opened. When the on-off valve 7 is temporarily opened, a part of the anode recirculation gas flowing through the reflux path is discharged (purged) to the outside, whereby a decrease in the hydrogen concentration of the anode supply gas can be suppressed, and the hydrogen concentration can be maintained at a certain level or more. The on-off valve 7 is controlled by the ECU 10.

The ECU 10 includes a computer including a CPU, a RAM, a ROM, an I/O interface, and other peripheral circuits. Sensors such as the pressure sensor 6, an accelerator opening sensor of the vehicle, and a stack temperature sensor are connected to the ECU 10, and detection values from the respective sensors are input to the ECU 10. In addition, each unit of the fuel cell system 100 such as the injector 5 and the on-off valve 7 is connected to the ECU 10, and the ECU 10 controls each unit of the fuel cell system 100 including the injector 5. The required power generation amount of the fuel cell system 100 is input to the ECU 10 through, for example, the accelerator opening sensor of the vehicle.

### <Calculation of Required Injection Amount Q>

The ECU 10 calculates a flow rate (required injection amount) Q of the fuel gas to be supplied to the anode flow path 2 of the fuel cell stack 1, based on the required power generation amount of the fuel cell system 100. More specifically, the required power generation amount of the fuel cell system 100 is calculated based on the accelerator opening detected by the accelerator opening sensor, and the flow rate (power generation consumption amount) of the fuel gas (hydrogen) consumed per unit time by the power generation in the fuel cell stack 1 is calculated. In addition, the flow rate (permeation amount) of the permeated hydrogen permeating from the anode side to the cathode side through the membrane electrode assembly, the discharge amount of the anode recirculation gas, the pressure fluctuation of a target pressure P0 of the fuel gas, and the feedback amount of the pressure P with respect to the target pressure P0 are calculated. Then, the feedback amount is added to the calculated power generation consumption amount, permeation amount, discharge amount, and pressure fluctuation (feedforward amount) to calculate a required injection amount Q.

### <Setting of Injection Cycle Tint>

The ECU 10 calculates a current value based on the required power generation amount of the fuel cell system 100, and calculates the hydrogen partial pressure of the anode supply gas (the pressure P of the fuel gas) based on the total pressure of the anode supply gas detected by the pressure sensor 6. Then, an injection cycle Tint corresponding to the calculated current value and the hydrogen partial pressure of the anode supply gas is calculated (set) with reference to a predetermined characteristic map. The injection cycle Tint is set to be shorter for a higher load having a larger current value and to be shorter for a lower hydrogen partial pressure of the anode supply gas.

### <Calculation of Maximum Injection Amount Qi of Each Injector>

The ECU 10 calculates a maximum injection amount Qi that each injector 5 can inject per unit time. Each injector 5 is controlled by PWM control, and the injection amount of the fuel gas injected by each injector 5 in one valve opening is adjusted by a duty ratio (Ti/Tint) which is a ratio of a valve opening time (pulse width) Ti to a cycle (injection cycle) Tint of a pulse waveform. The maximum injection amount Qi of each injector 5 is an injection amount at a duty ratio of 100%.

FIG. 2 is a time chart for explaining the injection order of the large-diameter injector 5a and the small-diameter injector 5b. As illustrated in FIG. 2, when the injection cycle Tint (t1) is set at time t1, the large-diameter injector 5a is first opened at the set injection cycle Tint (t1), and the injection of the fuel gas by the large-diameter injector 5a is started. Thereafter, when valve opening time Tia of the large-diameter injector 5a corresponding to the duty ratio elapses at time t2, the large-diameter injector 5a is closed to stop the fuel gas injection by the large-diameter injector 5a, and the small-diameter injector 5b is opened to start the fuel gas injection by the small-diameter injector 5b. Thereafter, when valve opening time Tib of the small-diameter injector 5b according to the duty ratio elapses at time t3, the small-diameter injector 5b is closed to stop the fuel gas injection by the small-diameter injector 5b.

As the large-diameter injector 5a, for example, there are a case where two large-diameter injectors 5a1 and 5a2 are used and a case where three large-diameter injectors 5a1 to 5a3 are used, and the plurality of large-diameter injectors 5a1 to 5a3 are controlled to be opened and closed simultaneously. In a case where two large-diameter injectors 5a1 and 5a2 are used, the effective cross-sectional area of the injection hole of the large-diameter injector 5a is twice that of one large-diameter injector 5a1. Similarly, in a case where three large-diameter injectors 5a1 to 5a3 are used, the effective cross-sectional area of the injection hole of the large-diameter injector 5a is three times that of one large-diameter injector 5a1.

The ECU 10 calculates each of a maximum injection amount Qia(2) of the two large-diameter injectors 5a1 and 5a2, a maximum injection amount Qia(3) of the three large-diameter injectors 5a1 to 5a3, and a maximum injection amount Qib of the small-diameter injector 5b. The maximum injection amount Qi can be calculated by the following equation using an effective cross-sectional area S, a pressure Pinj, a temperature Tinj, a specific heat ratio γ of hydrogen, and a gas constant R of each injector 5.

$$Qi = S \times Pinj / R / Tinj \times γ \times \{ 2 / ( γ + 1 ) \} \hat{} \{ ( γ + 1 ) / ( γ - 1 ) \}$$

### <Normal Injection>

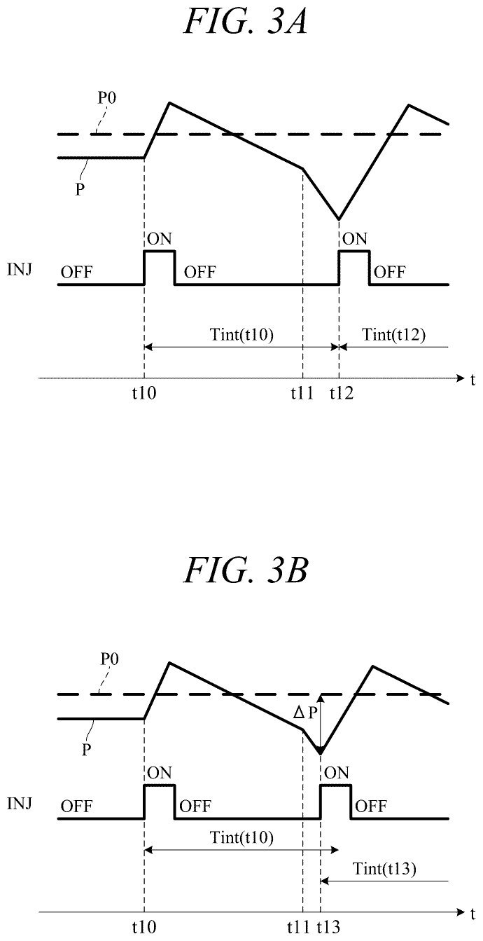

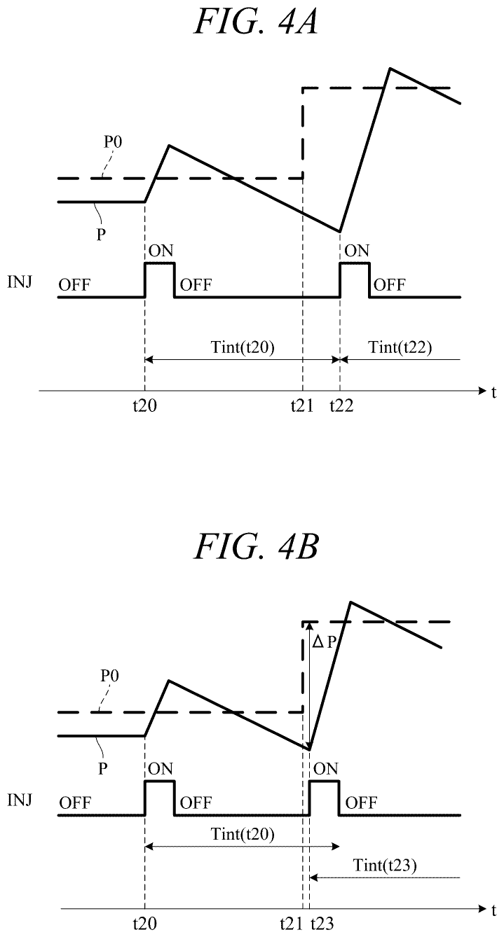

FIGS. 3A to 4B are time charts illustrating examples of a time change in the actual pressure P of the fuel gas calculated based on the target pressure P0 of the fuel gas and the detection value of the pressure sensor 6. The ECU 10 controls each injector 5 to inject a fuel gas (normal injection) for each set injection cycle Tint.

In the example of FIG. 3A, the injection cycle Tint (t10) is calculated at time t10, and when the injection cycle Tint (t10) elapses from time t10, the next injection cycle Tint (t12) is calculated at time t12. When the injection cycle Tint is calculated at times t10 and t12, the injector 5 is opened (turned on), the pressure P of the fuel gas increases to exceed the target pressure P0, and then the injector 5 is closed (turned off), and the pressure P of the fuel gas gradually decreases.

At this time, before the injection cycle Tint (t10) elapses at time t12, for example, the on-off valve 7 (FIG. 1) is opened and the anode recirculation gas is purged at time t11, so that the pressure P of the fuel gas may rapidly decrease. When the pressure P decreases and deviates from the target pressure P0, the hydrogen concentration at the anode electrode becomes insufficient, concentration overvoltage is consumed in order to increase the probability of exchange of electrons between the anode electrode and hydrogen and maintain the current value, and the output voltage (generated voltage) decreases.

In the example of FIG. 4A, the injection cycle Tint (t20) is calculated at time t20, and when the injection cycle Tint (t20) elapses from time t20, the injection cycle Tint (t22) is calculated at time t22. Then, before the injection cycle Tint (t20) elapses at time t22, for example, the accelerator pedal of the vehicle is depressed to increase the accelerator opening at time t21, so that the required power generation amount (current value) and the target pressure P0 of the fuel gas increase. In this case, when the pressure P of the fuel gas deviates from the target pressure P0, the generated voltage decreases.

### <Interrupt Injection>

In this regard, in the present embodiment, when a pressure difference ΔP between the actual pressure P of the fuel gas and the target pressure P0 becomes equal to or larger than a predetermined value α so as to suppress the generated voltage decrease due to the pressure decrease of the fuel gas, the interrupt injection for injecting the fuel gas earlier than the lapse of the injection cycle Tint is performed. That is, the ECU 10 controls the injector 5 to perform normal injection when the injection cycle Tint elapses, and controls the injector 5 to perform interrupt injection when the pressure difference ΔP becomes equal to or larger than the predetermined value α even when the injection cycle Tint has not elapsed.

In the example of FIG. 3B, when the pressure difference ΔP becomes equal to or larger than the predetermined value α at time t10 before the injection cycle Tint (t10) set at time t13 elapses, the next injection cycle Tint (t13) is set, and the injector 5 is controlled to perform the interruption injection. Accordingly, it is possible to prevent the pressure P of the fuel gas from decreasing and deviating from the target pressure P0, and to suppress the decrease in the generated voltage.

Also in the example of FIG. 4B, when the pressure difference ΔP becomes equal to or larger than the predetermined value α at time t20 before the injection cycle Tint (t20) set at time t23 elapses, the next injection cycle Tint (t23) is set, and the injector 5 is controlled to perform the interruption injection. Accordingly, the fuel pressure P can be rapidly increased before the pressure P of the fuel gas deviates from the target pressure P0, and the acceleration responsiveness of the vehicle can be improved.

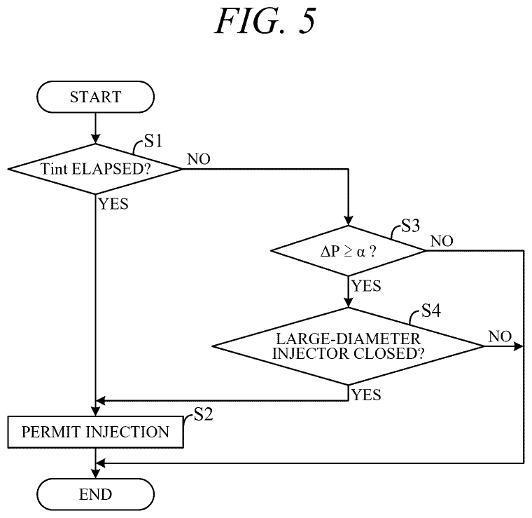

FIG. 5 is a flowchart illustrating an example of injection permission determination processing executed by the ECU 10. The processing of FIG. 5 is started when the ECU 10 is activated, and is repeatedly executed at a predetermined cycle. As illustrated in FIG. 5, first, in S1 (S: processing step), it is determined whether or not the injection cycle Tint has elapsed. If an affirmative determination is made in S1, the processing proceeds to S2, where the normal injection is permitted, and the processing ends. On the other hand, if a negative determination is made in S1, the processing proceeds to S3, where it is determined whether or not the pressure difference ΔP is equal to or larger than the predetermined value α. If an affirmative determination is made in S3, the processing proceeds to S4, and if a negative determination is made in S3, the processing ends. In S4, it is determined whether or not at least the large-diameter injector 5a is closed. if an affirmative determination is made in S4, the processing proceeds to S2, where the interrupt injection is permitted, and the processing ends. On the other hand, if a negative determination is made in S4, the processing ends without permitting the interrupt injection.

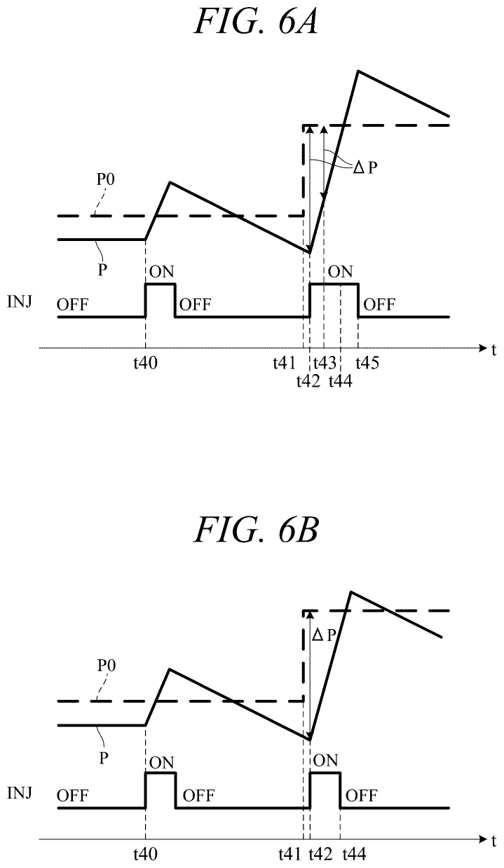

FIG. 6A is a time chart for explaining increase in the pressure of the fuel gas in a case where the interruption injection is permitted even when the large-diameter injector 5a is opened. In addition, FIG. 6B is a time chart for explaining increase in the pressure of the fuel gas in a case where the interruption injection is permitted on the condition that the large-diameter injector 5a is closed.

In the example of FIG. 6A, after the normal injection is performed at time t40, the required power generation amount (current value) and the target pressure P0 of the fuel gas increase at time t41, when the pressure difference ΔP becomes equal to or larger than the predetermined value α at time t42, the interrupt injection is permitted, and the valve opening of the injector 5 is commanded until time t44. Thereafter, when the pressure difference ΔP is equal to or larger than the predetermined value α even at time t43 before the valve closing of the injector 5 is commanded at time t44, the interrupt injection is further permitted, and the valve opening of the injector 5 is commanded until time t45. In this case, from time t42 to time t45, the injector 5 is opened beyond a normal valve opening time Ti, and the pressure P increases. When the pressure P becomes excessive with respect to the target pressure P0 and the hydrogen concentration in the anode electrode becomes excessive, there is a possibility that the power generation efficiency deteriorates or the membrane electrode assembly is damaged.

The ECU 10 permits the interrupt injection on condition that at least the large-diameter injector 5a is closed (S4 in FIG. 5). In this case, as illustrated in FIG. 6B, it is possible to prevent the pressure P from becoming excessive with respect to the target pressure P0, and to prevent an excessive amount of fuel gas from being supplied to the fuel cell stack 1.

### <Calculation of Valve Opening Time Ti of Each Injector>

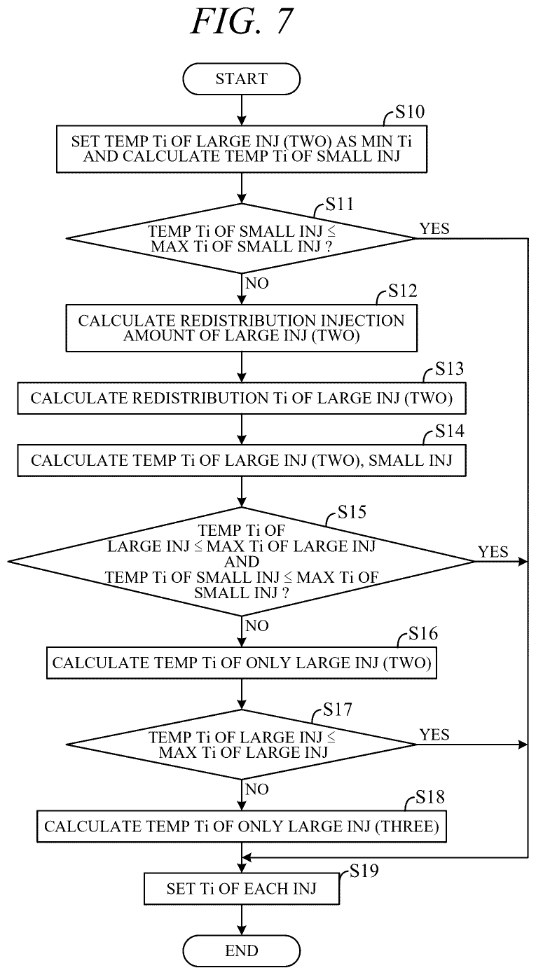

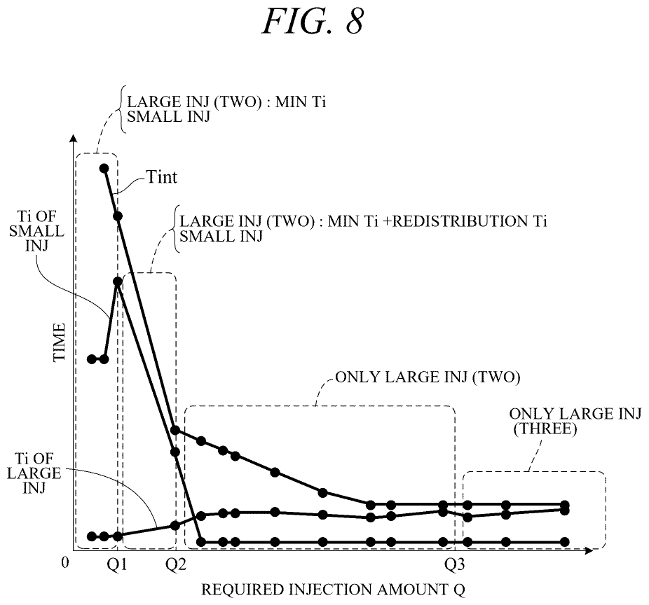

FIG. 7 is a flowchart illustrating an example of valve opening time setting processing executed by the ECU 10. The processing of FIG. 7 is executed when injection (normal injection, interrupt injection) is permitted in the injection permission determination processing of FIG. 5.

<Valve Opening Time Ti when Two Large-Diameter Injectors and Small-Diameter Injector are Used (when Valve Opening Time of Large-Diameter Injector is Set to Minimum Valve Opening Time)>

As illustrated in FIG. 7, first, in S10, temporary valve opening time Ti_tmp of each injector 5 is calculated assuming that the two large-diameter injectors 5a1 and 5a2 and the small-diameter injector 5b are used. In S10, temporary valve opening time Tia_tmp of the large-diameter injector 5a is set as predetermined minimum valve opening time Tia_min (for example, about 12 ms), and temporary valve opening time Tib_tmp of the small-diameter injector 5b is calculated.

More specifically, the injection cycle Tint, the maximum injection amount Qia(2) of the two large-diameter injectors 5a1 and 5a2, and the minimum valve opening time Tia_min of the large-diameter injector 5a are used to calculate the minimum injection amount Qia_min of the two large-diameter injectors 5a1 and 5a2 by the following equation.

$$Qia\_min = Tia\_min / Tint \times Qia ( 2 )$$

Then, the calculated minimum injection amount Qia_min of the two large-diameter injectors 5a1 and 5a2, the required injection amount Q, the injection cycle Tint, and the maximum injection amount Qib of the small-diameter injector 5b are used to calculate the temporary valve opening time Tib_tmp of the small-diameter injector 5b by the following equation.

$$Tib\_tmp / Tint \times Qib = Q - Qia\_min$$

Next, in S11, it is determined whether or not the temporary valve opening time Tib_tmp of the small-diameter injector 5b calculated in S10 is equal to or less than the maximum valve opening time Tib_max of the small-diameter injector 5b. The maximum valve opening time Ti_max of each injector 5 is determined as the shorter of the time corresponding to a predetermined ratio (for example, about 95%) of the injection cycle Tint and the time obtained by subtracting the minimum valve opening time Ti_min from the injection cycle Tint.

If an affirmative determination is made in S11, the processing proceeds to S19, where the valve opening time Tia of the large-diameter injector 5a is set to the minimum valve opening time Tia_min, and the valve opening time Tib of the small-diameter injector 5b is set to the temporary valve opening time Tib_tmp calculated in S10. When the valve opening time Ti of each injector 5 is set in S19, each injector 5 is controlled to inject the fuel gas based on the set valve opening time Ti.

<Valve Opening Time Ti when Using Two Large-Diameter Injectors and Small-Diameter Injector (when Valve Opening Time of Large-Diameter Injector is Set to be Longer than Minimum Valve Opening Time)>

On the other hand, if a negative determination is made in S11, the processing proceeds to S12, where a redistribution injection amount Qia_red, which the two large-diameter injectors 5a1 and 5a2 are to inject in addition to the injection at the minimum valve opening time Tia_min, is calculated. More specifically, the maximum injection amount Qib of the small-diameter injector 5b, the temporary valve opening time Tib_tmp of the small-diameter injector 5b, and the maximum valve opening time Tib_max of the small-diameter injector 5b are used to calculate the redistribution injection amount Qia_red by the following equation.

$$Qia\_red = Qib \times ( Tib\_tmp - Tib\_max )$$

Next, in S13, the redistribution valve opening time Tia_red, during which the two large-diameter injectors 5a1 and 5a2 are to continue valve opening (injection) beyond the minimum valve opening time Tia_min, is calculated. More specifically, the redistribution injection amount Qia_red calculated in S12, the maximum injection amount Qia(2) of the two large-diameter injectors 5a1 and 5a2, and the maximum injection amount Qib of the small-diameter injector 5b are used to calculate the redistribution valve opening time Tia_red by the following equation.

$$Tia\_red = Qia\_red / ( Qia ( 2 ) - Qib )$$

Next, in S14, the temporary valve opening time Ti_tmp of each injector 5 is calculated assuming that the two large-diameter injectors 5a1 and 5a2 and the small-diameter injector 5b are used. More specifically, the minimum valve opening time Tia_min of the large-diameter injector 5a, the maximum valve opening time Tib_max of the small-diameter injector 5b, and the redistribution valve opening time Tia_red calculated in S13 are used to calculate the temporary valve opening time Tia_tmp of the large-diameter injector 5a and the temporary valve opening time Tib_tmp of the small-diameter injector 5b by the following equation.

$$Tia\_tmp = Tia\_min + Tia\_red$$

$$Tib\_tmp = Tib\_max - Tia\_red$$

Next, in S15, it is determined whether or not the temporary valve opening time Tia_tmp of the large-diameter injector 5a calculated in S14 is a predetermined valve opening time (for example, the maximum valve opening time Tia_max of the large-diameter injector 5a or less), and whether or not the temporary valve opening time Tib_tmp of the small-diameter injector 5b is equal to or less than the maximum valve opening time Tib_max of the small-diameter injector 5b. The predetermined valve opening time is not limited to the maximum valve opening time Tia_max of the large-diameter injector 5a, and may be a fixed value separately set by a test or the like. If an affirmative determination is made in S15, the processing proceeds to S19, where the valve opening times Tia and Tib of the injectors 5a and 5b are set to the temporary valve opening times Tia_tmp and Tib_tmp calculated in S14. Note that instead of the processing of S15, whether or not the present current value (generated current value) of the fuel cell stack 1 is equal to or larger than a predetermined current value may be determined, the processing may proceed to S16 if an affirmative determination is made, and the processing may proceed to S19 if a negative determination is made. That is, when the generated current value is equal to or larger than the predetermined current value, even if the small-diameter injector 5b is used or only the large-diameter injector 5a is used without using the small-diameter injector 5b, under the operation condition that the power generation state is stabilized, the number of times of operations of the small-diameter injector 5b is reduced, and the power generation stability of the fuel cell stack 1 is enhanced while the deterioration due to wear of the small-diameter injector 5b is minimized.

<Valve Opening Time Ti when Only Two Large-Diameter Injectors are Used>

On the other hand, if a negative determination is made in S15, the processing proceeds to S16, where the temporary valve opening time Tia_tmp is calculated assuming that only the two large-diameter injectors 5a1 and 5a2 are used. More specifically, the required injection amount Q, the injection cycle Tint, and the maximum injection amount Qia(2) of the two large-diameter injectors 5a1 and 5a2 are used to calculate the temporary valve opening time Tia_tmp of the large-diameter injector 5a by the following equation.

$$Tia\_tmp / Tint \times Qia ( 2 ) = Q$$

Next, in S17, it is determined whether or not the temporary valve opening time Tia_tmp of the large-diameter injector 5a calculated in S16 is equal to or less than the predetermined valve opening time (for example, the maximum valve opening time Tia_max of the large-diameter injector 5a). If an affirmative determination is made in S17, the processing proceeds to S19, where the valve opening time Tia of the large-diameter injector 5a is set to the temporary valve opening time Tia_tmp calculated in S16, and the valve opening time Tib of the small-diameter injector 5b is set to “0”. Note that instead of the processing of S17, whether or not the generated current value of the fuel cell stack 1 is equal to or larger than a predetermined current value may be determined, the processing may proceed to S18 if an affirmative determination is made, and the processing may proceed to S19 if a negative determination is made.

<Valve Opening Time Ti when Only Three Large-Diameter Injectors are Used>

On the other hand, if a negative determination is made in S17, the processing proceeds to S18, where the temporary valve opening time Tia_tmp is calculated assuming that only the three large-diameter injectors 5a1 to 5a3 are used. More specifically, the required injection amount Q, the injection cycle Tint, and the maximum injection amount Qia(3) of the three large-diameter injectors 5a1 to 5a3 are used to calculate the temporary valve opening time Tia_tmp of the large-diameter injector 5a by the following equation. Next, in S19, the valve opening time Tia of the large-diameter injector 5a is set to the temporary valve opening time Tia_tmp calculated in S18, and the valve opening time Tib of the small-diameter injector 5b is set to “0”.

$$Tia\_tmp / Tint \times Qia ( 3 ) = Q$$

### <Combination of Load and Injector>

FIG. 8 is a diagram for explaining the valve opening time Ti of each injector 5 set by the ECU 10. As illustrated in FIG. 8, in a first load region (Q≤Q1) where the required power generation amount (load) of the fuel cell stack 1 is small and the required injection amount Q is equal to or less than a first threshold Q1, the temporary valve opening time Tib_tmp of the small-diameter injector 5b calculated in S10 of FIG. 7 is equal to or less than the maximum valve opening time Tib_max (Yes in S11). In such a first load region, the injection (normal injection, interrupt injection) is performed using the two large-diameter injectors 5a1 and 5a2 and the small-diameter injector 5b, and the valve opening time Tia of the large-diameter injector 5a is set to the minimum valve opening time Tia_min.

In a second load region (Q1<Q≤Q2) where the required power generation amount of the fuel cell stack 1 is slightly small and the required injection amount Q is larger than the first threshold Q1 and equal to or less than a second threshold Q2, the temporary valve opening time Tib_tmp of the small-diameter injector 5b calculated in S10 of FIG. 7 is larger than the maximum valve opening time Tib_max (No in S11). In addition, the temporary valve opening time Tia_tmp of the large-diameter injector 5a calculated in S14 is equal to or less than the maximum valve opening time Tia_max (Yes in S15). In such a second load region, the injection (normal injection, interrupt injection) is performed using the two large-diameter injectors 5a1 and 5a2 and the small-diameter injector 5b, and the valve opening time Tia of the large-diameter injector 5a is set to be longer than the minimum valve opening time Tia_min.

In a low load region (Q≤Q2) where the required power generation amount of the fuel cell stack 1 is relatively small and the required injection amount Q is relatively small, the valve opening time Ti per injection cycle Tint is shorter than that in the high load region (Q>Q2), and time (Tint-Ti) during which the injection is not performed is likely to be long, so that drainage of the anode flow path 2 may be delayed. In such a low load region, the small-diameter injector 5b in which the valve opening time Ti required for the same injection amount is longer than that of the large-diameter injector 5a is preferentially used, and the valve opening time Tib of the small-diameter injector 5b is set to be longer than the valve opening time Tia of the large-diameter injector 5a (Tia<Tib).

Accordingly, the valve opening time Ti (=Tia+Tib) per injection cycle Tint can be lengthened, and water (liquid) retained in the anode flow path 2 can be smoothly discharged to the outside of the fuel cell stack. In addition, by preferentially using the small-diameter injector 5b, even when the number of injections of the injector 5 increases due to the interruption injection, it is possible to minimize deterioration due to wear of the large-diameter injector 5a, which is essential for securing the required injection amount Q.

In a third load region (Q2<Q≤Q3) where the required power generation amount of the fuel cell stack 1 is slightly large and the required injection amount Q is larger than the second threshold Q2 and equal to or less than a third threshold Q3, the temporary valve opening time Tib_tmp of the small-diameter injector 5b calculated in S10 of FIG. 7 is larger than the maximum valve opening time Tib_max, and the temporary valve opening time Tia_tmp of the large-diameter injector 5a calculated in S14 is larger than the maximum valve opening time Tia_max (No in S11 and S15). In addition, the temporary valve opening time Tia_tmp of the large-diameter injector 5a calculated in S16 is equal to or less than the maximum valve opening time Tia_max (Yes in S17). In such a third load region, injection (normal injection, interrupt injection) is performed using only the two large-diameter injectors 5a1 and 5a2.

In a fourth load region (Q3<Q) where the required power generation amount of the fuel cell stack 1 is large and the required injection amount Q is larger than the third threshold Q3, the temporary valve opening time Tib_tmp of the small-diameter injector 5b calculated in S10 of FIG. 7 is larger than the maximum valve opening time Tib_max, the temporary valve opening time Tia_tmp of the large-diameter injector 5a calculated in S14 is larger than the maximum valve opening time Tia_max, and the temporary valve opening time Tia_tmp of the large-diameter injector 5a calculated in S16 is larger than the maximum valve opening time Tia_max (No in S11, S15, and S17). In such a fourth load region, injection (normal injection, interrupt injection) is performed using only the three large-diameter injectors 5a1 to 5a3.

In the high load region (Q>Q2) where the required power generation amount of the fuel cell stack 1 is relatively large and the required injection amount Q is relatively large, the valve opening time Ti per injection cycle Tint is likely to be longer than that in the low load region (Q≤Q2). In such a high load region, only the large-diameter injector 5a in which the valve opening time Ti required for the same injection amount is shorter than that of the small-diameter injector 5b is used, and the valve opening time Ti (=Tia) per injection cycle Tint is shortened. Accordingly, it is possible to reliably inject the required injection amount Q within the injection cycle Tint even in the high load region (Q>Q2) while preferentially using the small-diameter injector 5b and to satisfy the required power generation amount.

According to the present embodiment, the following operations and effects can be achieved.

(1) The fuel cell system 100 includes: the fuel cell stack 1 constituted by stacking a plurality of power generation cells; the injector 5 that injects a fuel gas supplied to the fuel cell stack 1; the pressure sensor 6 that detects a pressure P of the fuel gas supplied to the fuel cell stack 1; and the ECU 10 that sets the injection cycle Tint of the injector 5 and controls the injector 5 to inject the fuel gas in each injection cycle Tint (FIG. 1).

When the pressure difference ΔP between the pressure P detected by the pressure sensor 6 and the target pressure P0 becomes equal to or larger than the predetermined value α, the ECU 10 controls the injector 5 to inject the fuel gas earlier than the lapse of the injection cycle Tint (FIG. 5). As described above, the pressure P of the fuel gas supplied to the fuel cell stack 1 is constantly monitored, and when the pressure difference ΔP from the target pressure P0 becomes equal to or larger than the predetermined value α, the interrupt injection is performed without waiting for the elapse of the injection cycle Tint, so that it is possible to suppress the decrease in the generated voltage due to the decrease in the pressure of the fuel gas (FIGS. 3B and 4B).

(2) The ECU 10 calculates the required injection amount Q of the fuel gas based on a required power generation amount of the fuel cell stack 1, sets the injection cycle Tint based on the pressure P detected by the pressure sensor 6 and the required power generation amount, sets the valve opening time Ti of the injector 5 based on the required injection amount Q and the injection cycle Tint, and controls the injector 5 to inject the fuel gas based on the valve opening time Ti.

Even when the injection cycle Tint is set in consideration of the required injection amount Q and the pressure P in this manner, the pressure difference ΔP may become excessive before the set injection cycle Tint elapses, and the generated voltage may decrease (FIGS. 3A and 4A). By monitoring the pressure difference ΔP and performing interrupt injection without waiting for the elapse of the injection cycle Tint as necessary, it is possible to suppress a decrease in generated voltage due to a decrease in the pressure of the fuel gas (FIGS. 3B and 4B).

(3) The injector 5 includes the large-diameter injector 5a and the small-diameter injector 5b having a diameter smaller than that of the large-diameter injector 5a, and the valve opening time Ti includes the valve opening time Tia of the large-diameter injector 5a and the valve opening time Tib of the small-diameter injector 5b (FIG. 1). The ECU 10 sets the valve opening time Tib of the small-diameter injector 5b to be longer than the valve opening time Tia of the large-diameter injector 5a (Tia<Tib) when the required injection amount Q is equal to or less than the second threshold Q2 (Q≤Q2), and sets the valve opening time Ti of the large-diameter injector 5a to be longer than the valve opening time Ti of the small-diameter injector 5b (Tia>Tib=0) when the required injection amount is larger than the second threshold Q2 (Q>Q2) (FIG. 8).

Accordingly, the valve opening time Ti=(Tia+Tib) per injection cycle Tint can be lengthened, and water (liquid) retained in the anode flow path 2 can be smoothly discharged to the outside of the fuel cell stack. In addition, by preferentially using the small-diameter injector 5b, even when the number of injections of the injector 5 increases due to the interruption injection, it is possible to minimize deterioration due to wear of the large-diameter injector 5a, which is essential for securing the required injection amount Q.

(4) The ECU 10 sets the valve opening time Tia of the large-diameter injector 5a and the valve opening time Tib of the small-diameter injector 5b based on the minimum valve opening time Tia_min of the large-diameter injector 5a (FIG. 7). Accordingly, the small-diameter injector 5b can be preferentially used.

(5) The ECU 10 sets the valve opening time Tia of the large-diameter injector 5a to the minimum valve opening time Tia_min, calculates the minimum injection amount Qia_min of the large-diameter injector 5a (5a1, 5a2) based on the minimum valve opening time Tia_min, and sets the valve opening time Tib of the small-diameter injector 5b based on a difference (Q−Qa_min) between the required injection amount Q and the minimum injection amount Qia_min (S10, S19 in FIG. 7). Accordingly, the small-diameter injector 5b can be preferentially used in the first load region (Q≤Q1) (FIG. 8).

(6) The ECU 10 calculates the minimum injection amount Qia_min of the large-diameter injector 5a (5a1, 5a2) based on the minimum valve opening time Tia_min, and sets the temporary valve opening time Tib_tmp of the small-diameter injector 5b based on a difference between the required injection amount Q and the minimum injection amount Qia_min (S10 in FIG. 7). Then, when the temporary valve opening time Tib_tmp is equal to or less than the maximum valve opening time Tib_max of the small-diameter injector 5b, the valve opening time Tia of the large-diameter injector 5a (5a1, 5a2) is set to the minimum valve opening time Tia_min, and the valve opening time Tib of the small-diameter injector 5b is set to the temporary valve opening time Tib_tmp (Yes in S11->S19).

In addition, when the temporary valve opening time Tib_tmp is longer than the maximum valve opening time Tib_max, the valve opening time Tia of the large-diameter injector 5a (5a1, 5a2) is set based on a difference (Tib_tmp-Tib_max) between the temporary valve opening time Tib_tmp and the maximum valve opening time Tib_max, and the minimum valve opening time Tia_min, and the valve opening time Tib of the small-diameter injector 5b is set based on the difference (Tib_tmp-Tib_max) between the temporary valve opening time Tib_tmp and the maximum valve opening time Tib_max, and the maximum valve opening time Tib_max (No in S11->S12 to S14, S19). Accordingly, the small-diameter injector 5b can be preferentially used in the first load region (Q≤Q1) and the second load region (Q1<Q≤Q2) (FIG. 8).

(7) The ECU 10 calculates the minimum injection amount Qia_min of the large-diameter injector 5a (5a1, 5a2) based on the minimum valve opening time Tia_min, sets the temporary valve opening time Tib_tmp of the small-diameter injector 5b based on a difference (Q-Qa_min) between the required injection amount Q and the minimum injection amount Qia_min, and when the temporary valve opening time Tib_tmp of the small-diameter injector 5b is larger than the maximum valve opening time Tib_max of the small-diameter injector 5b, sets the temporary valve opening time Tia_tmp of the large-diameter injector 5a (5a1, 5a2) based on a difference (Tib_tmp-Tib_max) between the temporary valve opening time Tib_tmp and the maximum valve opening time Tib_max of the small-diameter injector 5b and the minimum valve opening time Tia_min (No in S11 of FIGS. 7→S12 to S14).

Then, when the temporary valve opening time Tia_tmp of the large-diameter injector 5a (5a1, 5a2) is equal to or less than a predetermined valve opening time (for example, the maximum valve opening time Tia_max of the large-diameter injector 5a), the injector 5 is controlled to inject the fuel gas by using the large-diameter injector 5a (5a1, 5a2) and the small-diameter injector 5b (Yes in S15->S19). In addition, when the temporary valve opening time Tia_tmp of the large-diameter injector 5a (5a1, 5a2) is longer than the predetermined valve opening time, the injector 5 is controlled to inject the fuel gas by using only the large-diameter injector 5a (5a1 and 5a2, or 5a1, 5a2, and 5a3) (No in S15→S16 to S19). Accordingly, it is possible to reliably inject the required injection amount Q within the injection cycle Tint even in the high load region (Q>Q2) while preferentially using the small-diameter injector 5b and to satisfy the required power generation amount.

(8) The ECU 10 controls the injector 5 to inject the fuel gas on condition that the large-diameter injector 5a is in a valve-closed state. Accordingly, it is possible to prevent an excessive amount of fuel gas from being supplied to the fuel cell stack 1.

(9) The ECU 10 calculates the minimum injection amount Qia_min of the large-diameter injector 5a (5a1, 5a2) based on the minimum valve opening time Tia_min, sets the temporary valve opening time Tib_tmp of the small-diameter injector 5b based on a difference (Q−Qa_min) between the required injection amount Q and the minimum injection amount Qia_min, and when the temporary valve opening time Tib_tmp of the small-diameter injector 5b is larger than the maximum valve opening time Tib_max of the small-diameter injector 5b, sets the temporary valve opening time Tia_tmp of the large-diameter injector 5a (5a1, 5a2) based on a difference (Tib_tmp-Tib_max) between the temporary valve opening time Tib_tmp and the maximum valve opening time Tib_max of the small-diameter injector 5b and the minimum valve opening time Tia_min (No in S11 of FIGS. 7->S12 to S14). Then, when the generated current value of the fuel cell stack 1 is less than a predetermined current value, the injector 5 is controlled to inject the fuel gas by using the large-diameter injector 5a (5a1, 5a2) and the small-diameter injector 5b (S19). In addition, when the generated current value is equal to or larger than the predetermined current value, the injector 5 is controlled to inject the fuel gas by using only the large-diameter injector 5a (5a1 and 5a2, or 5a1, 5a2, and 5a3) (S16 to S19). In this case, when the generated current value is equal to or larger than the predetermined current value, even if the small-diameter injector 5b is used or only the large-diameter injector 5a is used without using the small-diameter injector 5b, under the operation condition that the power generation state is stabilized, the number of times of operations of the small-diameter injector 5b is reduced, and the power generation stability of the fuel cell stack 1 can be enhanced while the deterioration due to wear of the small-diameter injector 5b is minimized.

In the above embodiment, an example in which three large-diameter injectors 5a1 to 5a3 and one small-diameter injector 5b are provided has been described with reference to FIG. 1 and the like, but the injector that injects a fuel gas is not limited to such an injector. For example, only a single injector may be provided. Also in this case, similarly, when a pressure difference between the detected pressure and the target pressure becomes equal to or larger than a predetermined value, the interrupt injection for injecting the fuel gas earlier than the lapse of the injection cycle can be performed.

In the above embodiment, an example in which at least two large-diameter injectors 5a1 and 5a2 are used has been described with reference to FIG. 7, FIG. 8, and the like, but the combination of injectors is not limited to the example. The combination of injectors can be appropriately determined according to the hole diameter of each injector or the like. For example, a combination in which one large-diameter injector 5a and one small-diameter injector 5b are used, and the valve opening time Tia of the large-diameter injector 5a is set to the minimum valve opening time Tia_min may be used as a combination at the time of low load.

The above embodiment can be combined as desired with one or more of the aforesaid modifications. The modifications can also be combined with one another.

According to the present invention, it becomes possible to suppress the decrease in the generated voltage due to the decrease in the pressure of the fuel gas.

Above, while the present invention has been described with reference to the preferred embodiments thereof, it will be understood, by those skilled in the art, that various changes and modifications may be made thereto without departing from the scope of the appended claims.

1. A fuel cell system, comprising:
a fuel cell stack constituted by stacking a plurality of power generation cells;
an injector configured to inject fuel gas to be supplied to the fuel cell stack;
a pressure sensor configured to detect a pressure of the fuel gas to be supplied to the fuel cell stack; and
a control unit configured to set an injection cycle of the injector and to control the injector to inject the fuel gas in the injection cycle, wherein
the control unit controls the injector to inject the fuel gas earlier than lapse of the injection cycle when a pressure difference between the pressure detected by the pressure sensor and a target pressure becomes equal to or larger than a predetermined value.

2. The fuel cell system according to claim 1, wherein
the control unit:
calculates a required injection amount of the fuel gas based on a required power generation amount of the fuel cell stack;
sets the injection cycle based on the pressure detected by the pressure sensor and the required power generation amount;
sets a valve opening time of the injector based on the required injection amount and the injection cycle; and
controls the injector to inject the fuel gas based on the valve opening time.

3. The fuel cell system according to claim 2, wherein
the injector includes a first injector and a second injector having a diameter smaller than that of the first injector, wherein
the valve opening time includes a first valve opening time of the first injector and a second valve opening time of the second injector, wherein
the control unit sets the second valve opening time to be longer than the first valve opening time when the required injection amount is equal to or less than a threshold, and sets the first valve opening time to be longer than the second valve opening time when the required injection amount is larger than the threshold.

4. The fuel cell system according to claim 3, wherein
the control unit sets the first valve opening time and the second valve opening time based on a minimum valve opening time of the first injector.

5. The fuel cell system according to claim 4, wherein
the control unit:
sets the first valve opening time to the minimum valve opening time;
calculates a minimum injection amount of the first injector based on the minimum valve opening time; and
sets the second valve opening time based on a difference between the required injection amount and the minimum injection amount.

6. The fuel cell system according to claim 4, wherein
the control unit:
calculates a minimum injection amount of the first injector based on the minimum valve opening time;
sets a temporary valve opening time of the second injector based on a difference between the required injection amount and the minimum injection amount;
when the temporary valve opening time is equal to or less than a maximum valve opening time of the second injector, sets the first valve opening time to the minimum valve opening time and sets the second valve opening time to the temporary valve opening time; and
when the temporary valve opening time is larger than the maximum valve opening time, sets the first valve opening time based on: a difference between the temporary valve opening time and the maximum valve opening time; and the minimum valve opening time, and sets the second valve opening time based on: the difference between the temporary valve opening time and the maximum valve opening time; and the maximum valve opening time.

7. The fuel cell system according to claim 4, wherein
the control unit:
calculates a minimum injection amount of the first injector based on the minimum valve opening time;
sets a temporary valve opening time of the second injector based on a difference between the required injection amount and the minimum injection amount;
when the temporary valve opening time of the second injector is larger than a maximum valve opening time of the second injector, sets a temporary valve opening time of the first injector based on: a difference between the temporary valve opening time of the second injector and the maximum valve opening time of the second injector; and the minimum valve opening time;
when the temporary valve opening time of the first injector is equal to or less than a predetermined valve opening time, controls the injector to inject the fuel gas by using the first injector and the second injector; and
when the temporary valve opening time of the first injector is larger than the predetermined valve opening time, controls the injector to inject the fuel gas by using only the first injector.

8. The fuel cell system according to claim 3, wherein
the control unit controls the injector to inject the fuel gas on condition that the first injector is closed.

9. The fuel cell system according to claim 4, wherein
the control unit:
calculates a minimum injection amount of the first injector based on the minimum valve opening time;
sets a temporary valve opening time of the second injector based on a difference between the required injection amount and the minimum injection amount;
when the temporary valve opening time of the second injector is larger than a maximum valve opening time of the second injector, sets a temporary valve opening time of the first injector based on: a difference between the temporary valve opening time of the second injector and the maximum valve opening time of the second injector; and the minimum valve opening time;
when a generated current value of the fuel cell stack is less than a predetermined current value, controls the injector to inject the fuel gas by using the first injector and the second injector; and
when the generated current value is equal to or larger than the predetermined current value, controls the injector to inject the fuel gas by using only the first injector.

10. The fuel cell system according to claim 3, wherein
the injector includes a plurality of the first injectors and the second injectors.
